(19) United States
(12) Patent Application Publication
(10) Pub. No.: US 2006/0146533 A1
(43) Pub. Date: Jul. 6, 2006

(54) Illuminating device for projector

(76) Inventors: Wen-Chieh Chen, Jubei City (TW); Shyi-Pyng Lee, Jubei City (TW)

Correspondence Address: LIN & ASSOCIATES INTELLECTUAL PROPERTY, P.O. BOX 2339, SARATOGA, CA, 95070-0339, US

(21) Appl. No.: 11/028,434

(22) Filed: Jan. 3, 2005

(51) Int. Cl. F21V 1/00

(52) U.S. Cl. 362/248; 362/230; 362/231; 362/800

(57) ABSTRACT

An illuminating device for a projector includes a reflector that is arcuate in shape for reflection and a light emitting diode (LED) light source. The LED light source includes a base having a first LED set and a second LED set respectively and oppositely mounted on a side of the base, a first encapsulation encapsulating the first LED set and a second encapsulation encapsulating the second LED set, wherein the LED light source is located at a focal length of the reflector.

### BACKGROUND OF THE INVENTION

1. Field of the Invention

The present invention relates to an illuminating device, and more particularly to an illumination device for a projector to enhance light convergence from the light emitting diodes of the illumination device.

2. Description of Related Art

With reference to FIG. 1, a conventional illumination device for a projector is shown and has a light source 10, a lens array 21 arranged in front of the light source 10, multiple color defectors 22 and a lens set 23. The light coming from the light source 10 passes through the lens array 21, the color deflectors 22 and emits out of the lens set 23. Because the light has to pass through a series of lenses and in order to have enough lighting for the image, the light source 10 has to have high light intensity. A mercury light bulb is the most frequently used light bulb to accomplish the objective.

With reference to FIG. 2, the conventional light path is shown. A light bulb 12 has an illuminating area defined by a diameter d. The position of the light bulb 12 is located at the focal length f of a reflector 11 so that a light 13 from a center of the light bulb 12 and reflected by the reflector 11 is parallel to x-axis. However, a light beam 14 coming an area other than the center of the light bulb 12 and reflected by the reflector 11 is not parallel to the x-axis. Therefore, the light distribution from the light bulb 12 and reflected by the reflector 11 is not uniform. Besides, because the bulb protecting the filament of the light bulb 12 is not uniform, the light intensity cannot be distributed uniformly. Furthermore, because the light from the light bulb 12 is distributed divergently from the center of the light bulb 12, when an angle of the light is larger angle alpha as shown in the drawing and the light does not pass through the lens array 21, the light beam 15 is not able to be reflected by the reflector 11 such that the projector suffers from a light intensity loss.

Furthermore, when the mercury light bulb emits light, invisible lights such as infrared light and ultraviolet (UV) light are also generated. The UV light is the cause of the interior deterioration of the projector and may cause injury to the eyes. The infrared light is able to generate massive heat to cause the interior of the projector to be in a high temperature environment, which is also a parameter of interior deterioration of the projector. The light beam 15 overshooting the reflector 11 will cause the peripheries of the projector to suffer from deterioration as well. Still, in order to have high light intensity, the pressure inside the light bulb is high and thus the user's safety becomes a major concern due to the possible explosion of the light bulb. Besides, high temperature will cause the filament to become ionized, which eventually will damage the light bulb and replacement of such an expensive light bulb is necessary. As a result, using this conventional light bulb not only deteriorates the interior elements of the projector, but also increases the cost.

### SUMMARY OF THE INVENTION

The primary objective of the present invention is to provide a light emitting diode for replacement of the conventional mercury light bulb so that the emitted light beams will be focused by the reflector and then uniformly distributed.

Other objects, advantages, and novel features of the invention will become more apparent from the following detailed description when taken in conjunction with the accompanying drawings.

### BRIEF DESCRIPTION OF THE DRAWINGS

FIG. 1 is a schematic view showing the structure and light path of a conventional projector;

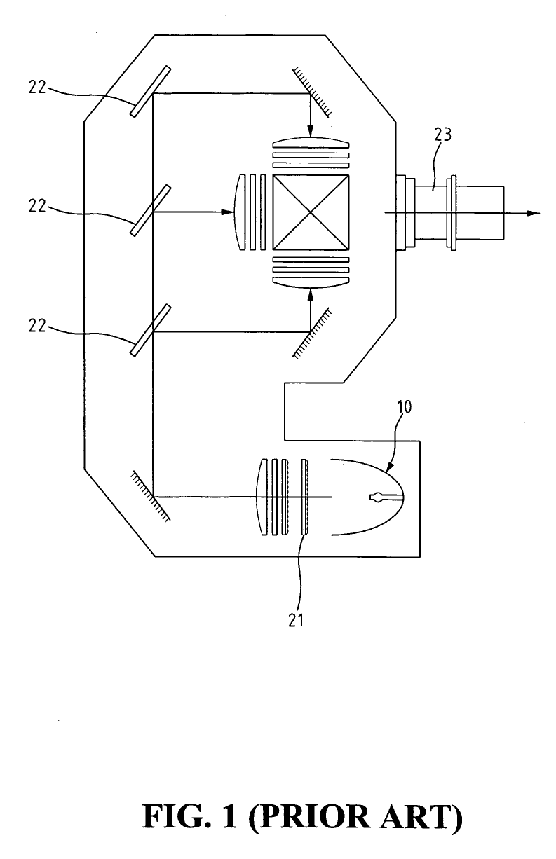

FIG. 2 is a schematic view showing the light beams of the conventional projector;

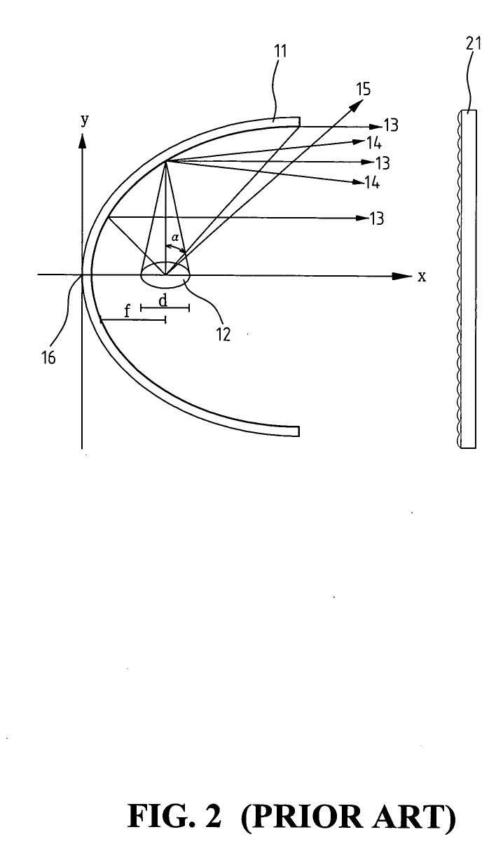

FIG. 3 is a schematic view showing the structure of the projector of the present invention;

FIG. 4 is a schematic top view of the structure of the projector of the present invention; and

FIG. 5 is a schematic view showing the light beam path of the present invention.

### DETAILED DESCRIPTION OF PREFERRED EMBODIMENT

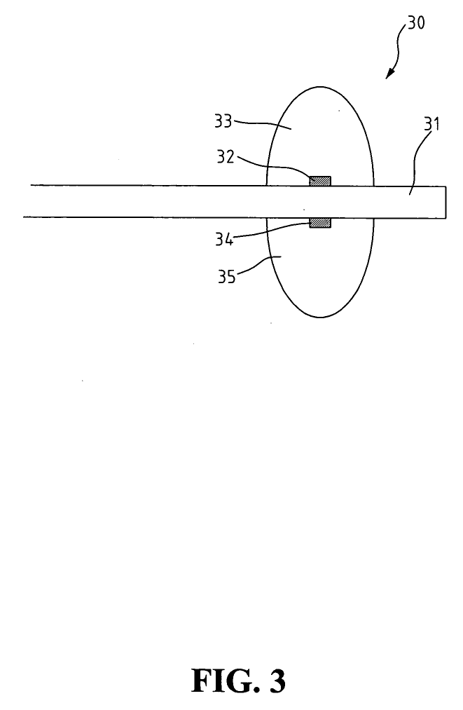

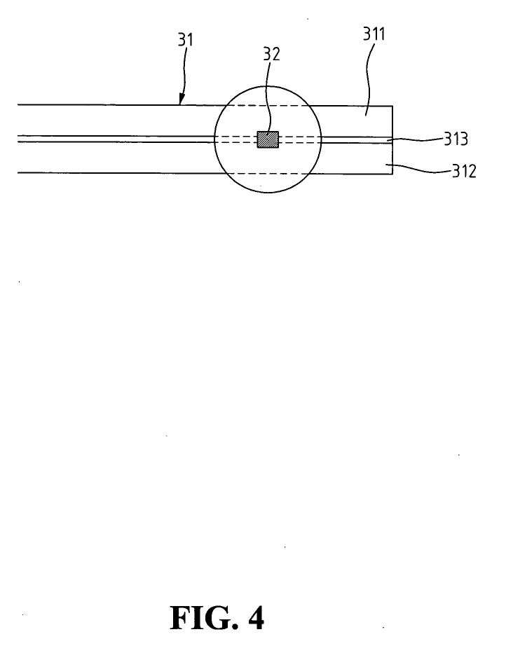

With reference to FIGS. 3 and 4, the illuminating device of the present invention includes a light emitting diode (LED) light source 30 and a reflector 11. The light beam from the LED light source 30 is focused by the reflector 11 to travel in a single direction as the light source of a projector. The LED light source 30 includes a base 31, a first LED set 32, a second LED set 34, a firs encapsulation 33 and a second encapsulation 35.

The base 31 is composed of a first base 311, a second base 312 and an insulation 313 securely sandwiched between the first base 311 and the second base 312. The first LED set 32 and the second LED set 34 are securely and oppositely mounted on a side of the base 31 and the first LED set 32 is extended from the first base 311, the insulation 313 and the second base 312. If the first LED set 32 has an electrode (not shown) on a bottom thereof, there is no wire bonding required. However, if there is no electrode on the bottom of the first LED set 32, a wire bonding process is performed among the first LED set, the first base 311 and the second base 312 to have an electrical communication among the first LED set 32, the first base 311 and the second base 312.

In order to avoid oxidation, after the electrical communication among the first LED set 32, the first base 311 and the second base 312 is accomplished, the first LED set 32 is encapsulated by the firs encapsulation 33 and the second LED set 34 is encapsulated by the second encapsulation 35. Both the first encapsulation 33 and the second encapsulation 35 are dome-shaped. The material for either the first encapsulation 33 or the second encapsulation 35 may be epoxy or the like. The dome-shaped encapsulation 33, 35 is to enable the light beam path to be parallel to the x-axis of the reflector 11 after reflection such that the reflected light beam by the reflector 11 is well within an area inside the reflector 11.

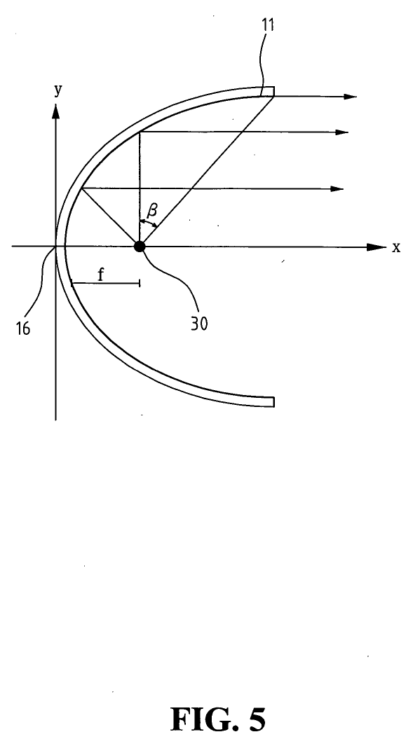

The first LED set 32 and the second LED set 34 are located on the x-axis of the reflector 11 and away from the reflector 11 for a distance f which is the focal length of the reflector 11. Because the base 31 is thin, the first LED set 32 and the second LED set 34 may be deemed as a point light source as shown in FIG. 5. Therefore, when a point light source is located at the focal length, the reflection of the light beam from the point light source by the arcuate reflector 11 is parallel to the x-axis of the reflector 11 such that the LED light source of the present invention is able to generate uniformly distributed light beam to diminish light loss. Furthermore, the light beam angle should be limited within angle beta.

The LED light source is a white light LED which may be a blue light LED energizing YAG yellow fluorescent matter, blue light LED energizing the RBG (red, blue and green) fluorescent matter, an ultraviolet (UV) light LED energizing the RBG (red, blue and green) fluorescent matter or a combination of blue LED and a yellow LED or the combination of the blue light LED, the green light LED and the red light LED which are encapsulated together. Another alternative is a combination of the red light LED, blue light LED and he green light LED as the LED light source of the present invention, which triples the light intensity when compared with the single white light LED.

The present invention may be applied to the light source of an electrical torch, a projector, a warning light system or a back light of a liquid crystal display (LCD).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An illuminating device for a projector, the illuminating device comprising:
a reflector which is arcuate in shape for reflection; and
a light emitting diode (LED) light source, which includes a base having a first LED set and a second LED set respectively and oppositely mounted on a side of the base, a first encapsulation encapsulating the first LED set and a second encapsulation encapsulating the second LED set, wherein the LED light source is located at a focal length of the reflector.

2. The illuminating device as claimed in claim 1, wherein the first encapsulation and the second encapsulation are dome-shaped so as to limit reflected light beam from the LED light source by the reflector to be within an area with in the reflector.

3. The illuminating device as claimed in claim 1, wherein the base is composed of a first base, a second base and insulation securely sandwiched between the first base and the second base.

4. The illuminating device as claimed in claim 2, wherein the base is composed of a first base, a second base, and insulation securely sandwiched between the first base and the second base.

5. The illuminating device as claimed in claim 4, wherein the LED light source is composed of a first LED set mounted on a side of the base and a second LED set mounted on a side of the base relative to the firs LED set, the first LED set is extended from the first base and the insulation to the second base.

6. The illuminating device as claimed in claim 5, wherein the LED light source is a white light LED.

7. The illuminating device as claimed in claim 5, wherein the LED light source is a blue light LED.

8. The illuminating device as claimed in claim 5, wherein the LED light source is a red light LED.

9. The illuminating device as claimed in claim 5, wherein the LED light source is a green light LED.
